(19) United States
(12) Patent Application Publication
(10) Pub. No.: US 2004/0030446 A1
(43) Pub. Date: Feb. 12, 2004

(54) Control system for automatic vending machines

(76) Inventor: Felix Guindulain Vidondo, Peralta (ES)

Correspondence Address: KLAUBER & JACKSON, 411 HACKENSACK AVENUE, HACKENSACK, NJ, 07601

(21) Appl. No.: 10/602,334

(22) Filed: Jun. 24, 2003

(30) Foreign Application Priority Data
Jun. 27, 2002 (ES) P200201478

(51) Int. Cl. G06F 17/00

(52) U.S. Cl. 700/241; 700/236

(57) ABSTRACT

Control system for automatic vending machines, especially applicable to automatic vending machines, in such a way that the system comprises a central server (1) connected to Internet (4), to which the associated operators or owners (2) of the automatic vending machines (3) to be controlled may have access. The automatic vending machines are provided with a public telephone, through computer equipment, the central server including equipment for the connection in real time or cyclical connection with each machine, data processing equipment and equipment for the management and control of the data of each machine, means to facilitate access to the data of each machine by the operators or owners associated to their corresponding machines and equipment to receive direct information from the machines concerning their operation.

### OBJECT OF THE INVENTION

As expressed in the title of the present specification, the following invention refers to a control system for automatic vending machines, especially applicable to coin-operated or card-operated vending machines, by means of which remote control and management of the machines by the operators or owners thereof is simplified.

Hence, the system is mainly based on one or more servers that include the suitable software, such as a management program, Internet page supplier software and data base software, which by means of the suitable safety mechanisms the operators or owners of the machines will be provided with a public telephone and the situation of each machine in real time or by a routine check thereof by the system in terms of the service hired.

Likewise, the machines provided with a public telephone may have a self-check program in order to report any incident, such as running out of a product or coins, possible failures in the machines, acts of vandalism, etc. to the central server.

With the proposed system, the owner of the system, mainly the manufacturer himself of the machines provided with a public telephone, can achieve very competitive costs given the large volume of lines to be hired from a telephony operator and the operators or owners of the machines achieve better costs in communication, which is easily attainable through Internet with a single telephone line.

### FIELD OF USE

Use of a control system for automatic vending machines is especially important for automatic vending machine operators, that control a certain number of these machines, as well as owners of automatic vending machines that are not at the place where the owners work, but rather the machines are located in certain establishments or public places. The system prevents the need to go to the place where each machine is located or else the hiring of a telephone line for each machine by means of the corresponding modem to be installed in each machine so that the situation and management thereof can be checked.

### BACKGROUND OF THE INVENTION

Conventionally in order to control these machines, the operators or owners thereof should make routine visits to the machines controlled checking them one by one and reloading, checking or repairing them if necessary. Management of the machines must be controlled.

This form of control is very costly given that many routine visits to the machine are not necessary, but they must be made, because if the machine has any operating problems, breaks down or runs out of a product or change and the users of these machines cannot use them, there is a significant economic loss, which increases the longer the machine does not operate correctly.

For the purpose of overcoming these inconveniences, operators of a certain number of automatic vending machines can organize management of their machines directly by installing a modem in their machines and hiring the corresponding telephone lines, as well as having the respective computer program.

This type of management has serious inconveniences, and, hence, aside from the economic cost involved, first of all due to the hiring of a limited number of telephone lines and the necessary infrastructure, there is the need for the operators to have a knowledge of computer science.

On the other hand, it is also possible for the operators or owners of the automatic vending machines to manage their machines by means of a firm that manages and controls the operating thereof, for which purpose a modem should be included in each one of the machines to be controlled and there should be corresponding telephone line hired by the operator of the machines himself.

This system has the serious inconvenience that the operators should make a big economic investment in the purchase of all the modems, and, besides, a monthly quota should be paid, making the system not very appropriate.

### DESCRIPTION OF THE INVENTION

The present specification describes a control system for automatic vending machines, especially applicable to automatic vending machines, in such a way that the system comprises a central server connected to Internet, to which the associated operators or owners of the automatic vending machines may have access by means of the corresponding computer equipment. The central server includes means for the connection in real time or cyclical connection with each machine, data processing means and means for the management and control of the data obtained from each machine, means to facilitate access to the data of each machine by the operators or owners associated to their corresponding machines and means to receive direct information from the machines concerning their operation.

Hence, the central server, that may be controlled by the machine manufacturer himself, has hired the telephone lines corresponding to each one of the machines to be controlled, to a telephony operator to communicate, by means of the public telephone itself that the machines are provided with, each one of the machines with the central server. Communication between the central server and the machine may be bidirectional and it is possible to control any operating function of the machines, such as the prices.

The means for the connection in real time or cyclical connection with each automatic vending machine to be controlled, said connection being carried out, automatically are defined by means of a program included by the central server and the public telephones themselves included in the machines.

On the other hand, the means for processing the data obtained by the central server in each connection to the machines to be controlled and their subsequent management and control are carried out in the central server by means of a program that updates and stores said data, in order to be included in the corresponding storage mechanism, guaranteeing the confidentiality of the data to each one of the operators or owners.

The means to facilitate access to the data stored in the central server, regarding each one of the machines to be controlled to the respective operators or owners of the corresponding machines is carried out through Internet, from any computer equipment that the operators or owners of the machines have, once the safety requirements of those that the system has are checked. At that time the central server is going to provide the operator with information requested by said operator about his machines.

The means to receive information from the machines regarding their state and operation is carried out by the public telephone itself by a self-check and control program, so that by means of the public telephone, contact is made with the central server in order to be able to report any incident that has taken place. The central server can notify the operator or owner of the machine that the incident has taken place, by means of notice given to the computer equipment itself, or by other means, such as SMS (message to mobile phones, fax, etc.)

On the other hand, the machines may include an internal modem associated to the corresponding telephone line thereof for communication of each one of the machines with the central server, that is to say, instead of a public telephone, the machines will include a modem.

In order to complete the description that is going to be made hereinafter and for the purpose of providing a better understanding of the characteristics of the invention, the present specification is accompanied by a diagram, in whose sole FIGURE the most characteristic details of the invention are represented in an illustrative and non-restrictive manner.

### BRIEF DESCRIPTION OF THE DRAWINGS

FIG. 1 shows the system wherein the connection among the different elements thereof is represented.

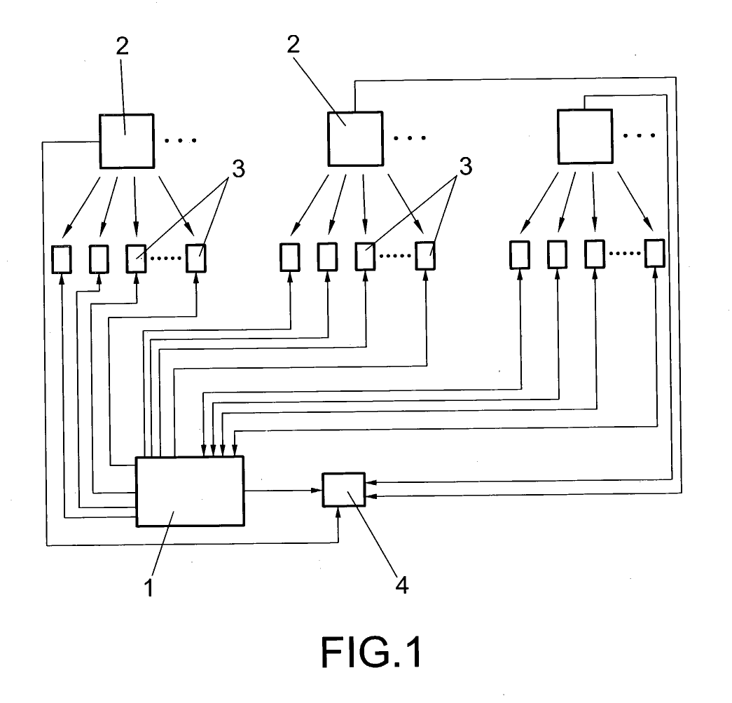

### DESCRIPTION OF A PREFERRED EMBODIMENT

In view of the commented FIGURE and in accordance with the numbering used, we can see how the system comprises a central server (1) connected to Internet (4), to which the associated operators or owners (2) that manage the automatic vending machines (3) may have access by means of the corresponding safety standard and by means of the corresponding computer equipment.

On the other hand, the central server (1) has all the telephone lines hired from a telephony operator in order to control by the public phone itself that the machines include, logically, along with the corresponding telephone line, the operating of the machines. There may be communication between the central server (1) and the bidirectional machines (3).

In this way, the central server (1) which may be the machine (3) manufacturer himself, which hires all the telephone lines, may obtain some very competitive prices from the corresponding telephony operator, having a repercussion on the machine (3) operators themselves (2). Hence, the holder of the central server pays the expenses regarding all the telephones.

Likewise, the central server (1) includes means for the connection in real time or a cyclical connection of the central server (1) with each one of the machines (3) to be controlled, in such a way that said connection is carried out automatically by means of a program included by the central server (1) and the means of the public telephone itself that each one of the machines (3) includes.

Similarly, the system includes some means for processing the data obtained by the central server (1) in each connection with the machines (3) to be controlled and the subsequent management and control thereof, which are carried out in the central server (1) by means of a program that updates and stores said data, in order to be included in the corresponding file that includes a safety standard which guarantees the confidentiality of the data to each one of the operators or owners (2).

Access of the respective operators or owners (2) to the data stored in the central server (1), regarding each one of their associated machines (3) is carried out by means of Internet (4), from any computer equipment by the operators or owners, by means of the use of the management or control programs of the central server (1)

Hence, the vending machine operators (2) need only have computer equipment and an Internet connection in order to be able to know the state of all their machines simply and rapidly without the need of having a knowledge of computer science.

The system includes some means to receive information from the machines (3) regarding their operation, which are defined by a self-check and control program of the public telephone itself, it being possible for them to contact the central server (1) in order to report any possible incident that has taken place and the central server (1) can report the incident that has taken place the operator or owner (2) of the machine (3) notice given to the computer equipment itself, or by other means, such as mobile phones, fax, etc.

In short, the present specification describes a system that facilitates the control of vending machines for the operators or owners thereof, with the added advantage represented by a minimum cost, and, that, even depending on the telephone calls made from the public telephones, money can be earned, since, the owner of the server is billed for the cost of the telephone calls, there may be a significant surplus.

1. A control system for automatic vending machines especially applicable to automatic vending machines, wherein the system comprises a central server connected to Internet, to which the associated operators or owners of the automatic vending machines to be controlled may have access, the automatic vending machines being provided with a public telephone, by means of computer equipment, the central server including means for the connection in real time or cyclical connection with each machine, data processing means and means for the management and control of said data of each machine, means to facilitate access to the data of each machine by the operators or owners associated to their corresponding machines and means to receive direct information from the machines concerning their operation.

2. The control system for automatic vending machines, according to claim 1, wherein the central server has hired telephone lines corresponding to each one of the machines to be controlled from a telephony operator in order to communicate by means of the public telephone itself that the machines are provided with, each one of the machines with the central server, it being possible for the communication between the central server and the machine to be bidirectional.

3. The control system for automatic vending machines, according to claim 1, wherein the means for connection in real time or cyclical connection of the central server which each machine, are defined by a program included by the central server and the public telephone itself included in the machines.

4. The control system for automatic vending machines, according to claim 1, wherein the means for processing the data obtained by the central server in each connection with the associated machines and subsequent management and control of the data are defined by means of a program that updates and stores said data in order for same to be included in the corresponding file that includes a safety standard that guarantees the confidentiality of the data to each one of the operators or owners.

5. The control system for automatic vending machines, according to claim 1, wherein the means for facilitating access to the data stored in the central server corresponding to each one of the associated machines to the respective operators or owners are based on a connection to Internet from computer equipment by the operators or owners by means of using the management and control programs of the central server.

6. The control system for automatic vending machines, according to claim 1, wherein the means for receiving information from the machines regarding their operation are defined by the self-check and control program that the machines themselves include, and that by means of the public telephone itself included in the machines, contact is made with the central server in order to report the incident that has taken place, the central server being able to notify the operator or owner of the machine, by means of reporting the incident that has taken place to the computer equipment itself, or other equipment.

7. The control system for automatic vending machines, according to claim 1 wherein the machines may include an internal modem associated to the corresponding telephone line thereof for the communication of each one of the machines with the central server.
